(19) United States
(12) Patent Application Publication
(10) Pub. No.: US 2004/0006503 A1
(43) Pub. Date: Jan. 8, 2004

(54) Commodity management system

(76) Inventor: Christopher J. Jarvis, Cary, NC (US)

Correspondence Address: Finnegan, Henderson, Farabow,, Garrett & Dunner, L.L.P., 1300 I Street, N.W., Washington, DC, 20005-3315, US

(21) Appl. No.: 10/186,992

(22) Filed: Jul. 2, 2002

(51) Int. Cl. G06F 17/60

(52) U.S. Cl. 705/10

(57) ABSTRACT

A method is provided for establishing a cost model for a commodity, including identifying a plurality of suppliers of the commodity and analyzing the commodity to determine cost drivers associated with supplying the commodity. A supplier-specific cost is determined for each of the cost drivers for the plurality of suppliers, and the supplier-specific costs are compared to establish a commodity cost model. The commodity cost model may be used to obtain and retain lower prices from commodity suppliers.

### TECHNICAL FIELD

The present invention relates generally to commodity management and, more particularly, to a system and method for establishing the price of a commodity by studying the costs related to providing the commodity.

### BACKGROUND

Managing commodity prices is an important aspect of many businesses. Commodity prices may affect profits, the quality and reliability of products, and development time for new products. Businesses that rely on commodity purchases may include, for example, manufacturers of construction equipment and automobile manufacturers. Indeed, businesses in almost every industry are faced with the need to manage the prices of commodities purchased from one or more suppliers.

Commodities may include raw materials that are generally fungible and often may be purchased from the lowest cost supplier. Commodities may also be designed to meet a purchaser's specifications. These may include, for example, cylinders, seats, and cooling packages. Additionally, commodities including harnesses, machined components, hoses, and tubes may be specially-produced for a purchaser. Such specially-produced or designed commodities may be purchased from a supplier chosen prior to production or design. This may give the supplier leverage over the price of the commodity. For example, once a supplier provides unique commodities to a purchaser, it becomes more difficult for the purchaser to change suppliers, thus reducing the bargaining power the purchaser holds over prices of specially-produced or designed commodities. Other commodities may include large commodities such as engines, pumps, and axles, with few suppliers typically available in the market. In an industry with few suppliers, a purchaser's options may be limited, resulting in decreased control over commodity prices. Additionally, prices for large commodities may be dictated by market forces beyond the control of the purchaser.

Currently available commodity management systems do not adequately serve commodity purchasers because suppliers and market forces exert a great deal of control over commodity prices. With little control over commodity prices, purchasers retain less control over their own profits. A purchaser may negotiate with suppliers, but price reductions gained through negotiations may not be enough for the purchaser to stay competitive or to achieve a desired level of profitability. For instance, in a market with relatively few suppliers, competing businesses needing to purchase the same commodity likely end up paying similar prices, minimizing any advantages sought by a single purchaser.

Product quality and reliability may also be compromised by the lack of control over prices faced by purchasers using current commodity management systems. For example, a business may not be able to afford the most expensive commodities and may instead purchase lower cost commodities that are also lower in quality, resulting in a lower quality end product. If a purchaser can obtain lower prices for high quality commodities, the quality of the end product may be improved.

Furthermore, in current commodity management systems, the negotiation of commodity prices can be a lengthy process, slowing new product development and production. Selecting a preferred supplier may speed the price negotiation process, but doing so likely reduces the leverage the purchaser has over prices. Once a supplier achieves “preferred” status, the supplier may lose some incentive to keep prices low. If a business relies on the supplier to participate in the design process of a commodity, price negotiations can further slow the design process.

Additionally, current commodity management systems make it difficult to control or predict prices into the future. While a supplier might be willing to agree to a price for a short while, long-term agreements are hard to reach because underlying costs and markets can vary greatly over time.

Some current business systems manage supply chains to ensure that demand for an end product is met. One such system is disclosed in U.S. Pat. No. 6,157,915 for a Method and Apparatus for Collaboratively Managing Supply Chains. This system manages decision making in a supply chain by organizing various role players, such as vendors and assemblers, within a supply chain. However, this system does not analyze a commodity to determine cost drivers associated with supplying the commodity. Nor does it assist a supplier in controlling commodity costs. Additionally, the disclosed system makes planning documents available to role players throughout a supply chain to track demand and the steps taken throughout the supply chain to meet that demand. The system does not, however, determine supplier-specific costs for cost drivers nor does it establish a commodity cost model.

The present disclosure is directed to overcoming one or more of the problems or disadvantages associated with the prior art.

### SUMMARY OF THE INVENTION

One aspect of the disclosure involves a method for establishing a cost model for a commodity, including identifying a plurality of suppliers of the commodity and analyzing the commodity to determine cost drivers associated with supplying the commodity. A supplier-specific cost is determined for each of the cost drivers for the plurality of suppliers, and the supplier-specific costs are compared to establish a commodity cost model.

Another aspect of the disclosure involves a method for establishing a Best in Class cost model for a commodity by identifying a plurality of suppliers of the commodity and establishing a plurality of cost drivers that contribute to a total cost of the commodity. An actual cost for each cost driver is determined for each of the plurality of suppliers, and the lowest actual cost for each cost driver is combined to create the Best in Class cost model for the commodity.

Yet another aspect of the disclosure involves a method for analyzing costs of a commodity by analyzing the commodity to determine cost drivers associated with supplying the commodity and determining a supplier-specific cost for each cost driver for a plurality of suppliers of the commodity.

An industry mean for each cost driver is calculated based on the supplier-specific costs to create an industry mean cost model.

Still further, consistent with the present disclosure a system is provided for establishing a cost model for a commodity with a commodity analysis processor that determines a plurality of cost drivers associated with supplying the commodity, a supplier interface that obtains a supplier-specific cost for each cost driver from a plurality of suppliers of the commodity, and a cost analysis processor that compares the supplier-specific costs to establish a commodity cost model.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate an exemplary embodiment of the invention and together with the description, serve to explain the principles of the invention. In the drawings:

FIG. 1 is a block diagram of a commodity management system, consistent with an exemplary embodiment of the present invention;

FIG. 2 is a flowchart of an exemplary commodity management method, consistent with the present invention;

FIG. 3 is a flowchart of another exemplary commodity management method, consistent with the present invention; and

FIGS. 4A-4D are tables depicting an exemplary commodity management process, consistent with the present invention.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

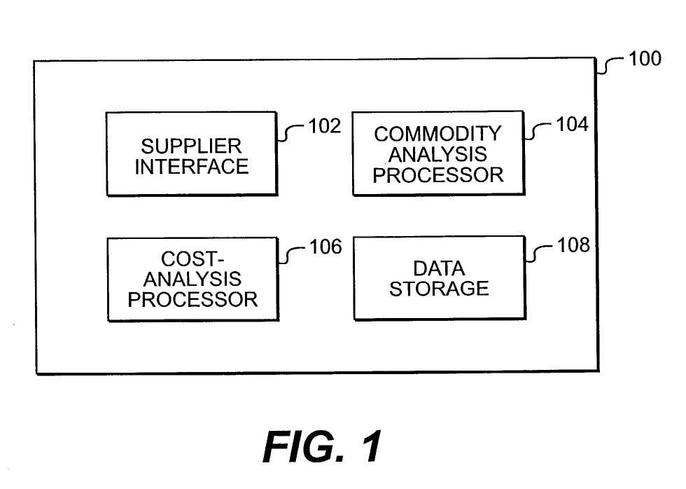

FIG. 1 illustrates a commodity management system 100, consistent with an exemplary embodiment of the present invention. Commodity management system 100 may enable a purchaser of commodities to analyze commodities and commodity costs for one or more suppliers in order to control the price of commodities purchased. Commodity management system 100 may include a supplier interface 102, a commodity analysis processor 104, a cost analysis processor 106, and data storage 108. Commodity management system 100 may be used for any type of commodities, including, for example, raw materials, commodities specially designed or produced for a purchaser, machine components, and large commodities. Such examples include, but are not limited to, cylinders, seats, cooling packages, harnesses, machined components, hoses, and tubes.

Using commodity management system 100, a purchaser or other party may manage a commodity by evaluating the commodity from a supplier's standpoint. By understanding suppliers' cost structures, a purchaser may create a model cost structure that achieves, for example, an industry-wide average cost or a best possible cost. The model cost structure may be used, for example, in negotiations with suppliers or to assist the purchaser in selecting a supplier.

Furthermore, by working with suppliers using commodity management system 100, a purchaser may achieve lower costs for a supplier and ultimately lower commodity prices for the purchaser.

Supplier interface 102 enables commodity management system 100 to interact with one or more suppliers and may include, for example, a computer program including a spread sheet program. Supplier interface 102 may also include a network interface enabling suppliers to interact with commodity management system 100 via a network, such as the Internet. In one embodiment, the supplier interface may be a user interface enabling manual entry of supplier-related information. Commodity analysis processor 104 may include, for example, a computer program for analyzing a commodity or any type of tool for implementing methods consistent with the present invention. In one embodiment, the cost analysis and commodity analysis processors are the same.

Cost analysis processor 106 may include, for example, a computer program for analyzing costs or any type of tool for implementing methods consistent with the present invention. Data storage 108 may include, for example, a database or any other component for storing data used by commodity management system 100. Data storage 108 may store, for example, supplier information, cost driver data, data collection tools, etc. A cost driver may generally be described as an issue that impacts the cost of the commodity.

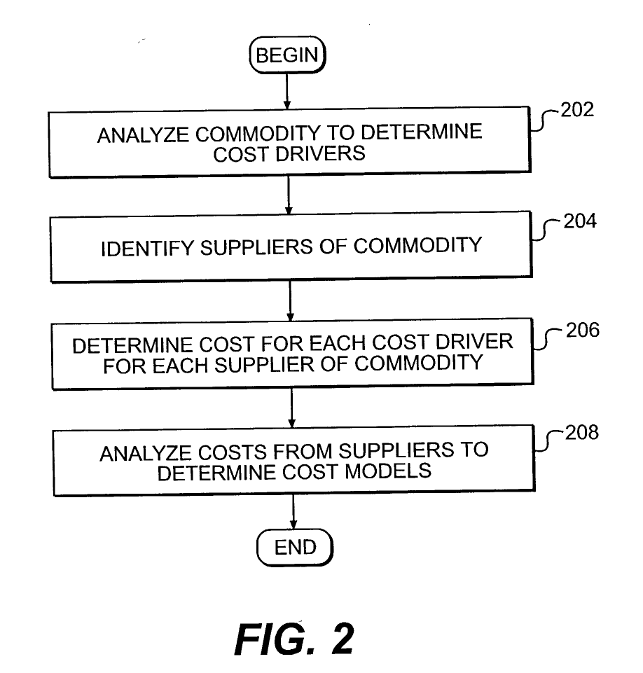

FIG. 2 is a flowchart of an exemplary commodity management process. In one embodiment, the process may be associated with a computer system such as commodity management system 100. Commodity analysis processor 104 may evaluate a commodity to determine cost drivers that contribute to the overall cost of providing the commodity (step 202). To do so, commodity analysis processor 104 may consider, for example, the materials that make up the commodity as well as a process for providing the commodity. The commodity may be analyzed using input from, for example, a supplier, a purchaser, or both. The cost drivers of the commodity may be determined in part based on this input. Supplier interface 102 may identify suppliers of the commodity, including, for example, current and potential suppliers on a local, national, or global scale (step 204). In one embodiment, the supplier interface may have access to a repository of potential suppliers that may be searched. Using supplier interface 102, commodity management system 100 may communicate with suppliers of the commodity to determine costs for each identified cost driver (step 206). Cost analysis processor 106 may analyze the suppliers' costs to create cost models to assist a purchaser in managing commodity prices (step 208).

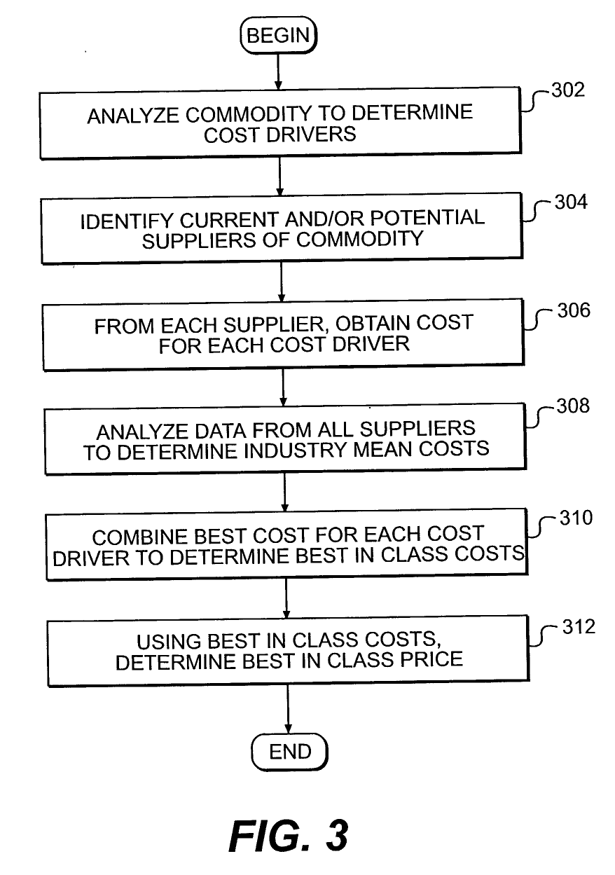

FIG. 3 is a flowchart of another exemplary commodity management process using commodity management system 100. Commodity analysis processor 104 may evaluate a commodity to determine cost drivers that make up a supplier's overall cost for providing the commodity (step 302). For example, a commodity may be evaluated by identifying a process flow of the steps a supplier takes to produce the commodity. Such a process flow might include steps identified as cost drivers, such as purchasing raw material, operations, logistics, and overhead.

Where the identified cost drivers are more general categories or steps, the cost drivers could be further analyzed to identify sub-cost drivers that contribute to the overall cost of the associated cost driver or commodity. For example, the raw material cost driver associated with a commodity such as a wire harness might include sub-cost drivers such as wire, connectors, or braid. The operations cost driver might include sub-cost drivers such as splicing, cutting, and crimping. Logistics might include sub-cost drivers such as freight, in-plant costs, and inventory. Overhead might include depreciation and inventory holding costs. In this way, a commodity may be broken down into a collection of cost drivers (and sub-cost drivers) that, taken together, constitute the cost to a supplier of providing the commodity. Cost drivers may include different volume levels. For example, a supplier may pay different prices for a raw material depending on the quantity of raw material purchased by the supplier. Accordingly, one cost driver may be the cost of the raw material at one volume and a second cost driver may be the cost of the raw material at another volume. Cost drivers could also be linked to other features of the product, for example, length, size, pressure, supplier's source, etc.

Supplier interface 102 may identify suppliers of the commodity, including, for example, current and potential suppliers on a regional, national, or global scale (step 304). The collection of cost drivers may be used to produce a data collection tool, such as a spreadsheet of the cost drivers, for obtaining supplier-specific costs. Via supplier interface 102, commodity management system 100 may communicate with the identified suppliers to obtain the supplier's cost for each cost driver using the data collection tool (step 306). Because the data collected from each supplier may be quite detailed, suppliers may be provided with confidentiality agreements or similar assurances of the protection of their cost data.

Cost analysis processor 106 may analyze the suppliers' costs to create cost models including, for example, a cost model for each supplier or a composite model for an entire industry. For each cost driver, cost analysis processor 106 may calculate a mean of all of the supplier's costs to achieve an industry mean cost structure (step 308). In one embodiment, a Best in Class cost model may be developed by combining the best supplier cost for each cost driver (step 310). By combining the Best in Class costs, a Best in Class price for the commodity may be calculated (step 312). Consistent with the present invention, other cost models could be produced using cost analysis processor 106. For example, supplier costs could be compared for an individual cost driver, for sub-cost drivers within a cost driver, or for an overall commodity price. Cost analysis processor 106 may include, for example, a spreadsheet program to assist in the analysis. Multi-variant analysis and box plot tools could also be used to analyze the data further.

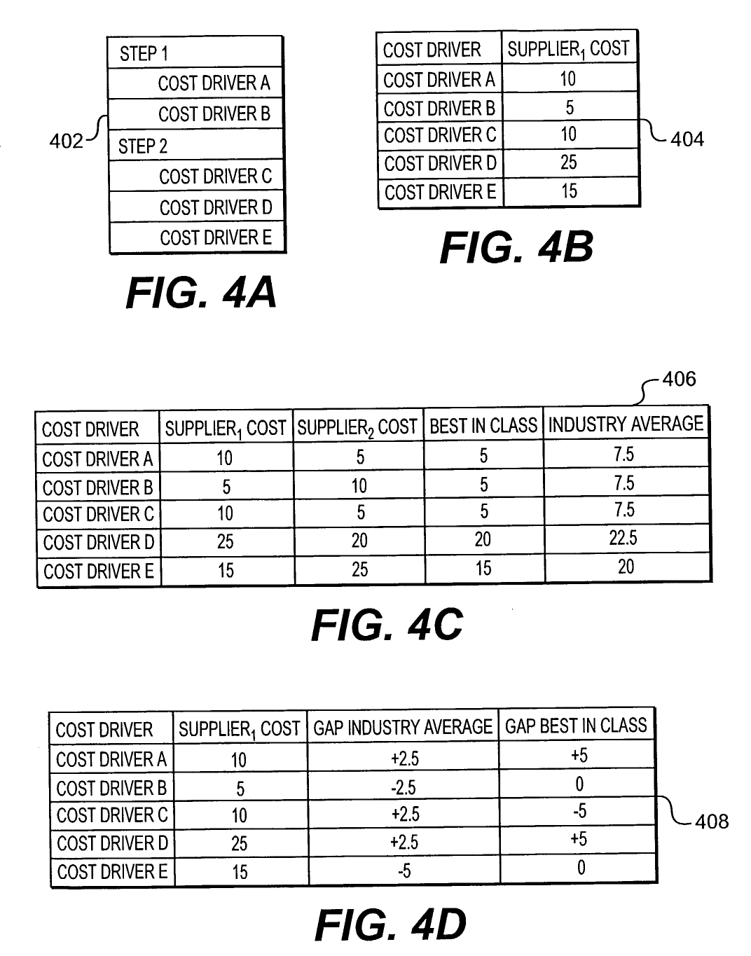

FIGS. 4A-4D are tables depicting an exemplary commodity management process. In one embodiment, the process may be implemented using commodity management system 100. Table 402 is a sample table that may be produced (e.g., by commodity analysis processor 104) to describe the cost drivers and sub-cost drivers that constitute a commodity's cost. For example, providing a given commodity may entail two steps or cost drivers, shown as Step 1 and Step 2. For example, Step 1 may be purchasing raw materials and Step 2 may be operations to combine the raw materials to create the commodity. Each step or cost driver may in turn consist of sub-cost drivers. For example, Step 1 may include Cost Driver A and Cost Driver B. If Step 1 is purchasing raw materials, then Cost Driver A may be, for example, “Cost of wire” and Cost Driver B may be, for example, “Cost of tube.” As shown in Table 402, Step 2 may include Cost Driver C, Cost Driver D, and Cost Driver E. If Step 2 is operations, then, for example, Cost Driver C may be “Clip wire,” Cost Driver D may be “Trim tube,” and Cost Driver E may be “Attach wire to tube.” In this way, Table 402 depicts one exemplary embodiment of the analysis of a commodity that may be produced by commodity analysis processor 104. One skilled in the art will recognize that the analysis of a commodity may be represented as a table, as shown in FIG. 4A, or in any other format. Furthermore, although Table 402 depicts two steps or cost drivers and five sub-cost drivers, the analysis of a commodity may include any number of steps or cost drivers and sub-cost drivers consistent with the present invention.

Table 404 is a sample data collection tool that may be used to obtain and/or record cost data associated with a supplier (e.g., via supplier interface 102). For example, each supplier may be given a list of cost drivers and asked to provide its cost for each cost driver. Consistent with the present invention, a data collection tool may implement an Open Book format, which includes a document generally characterized as a standardized spreadsheet provided by a potential purchaser to potential suppliers for purposes of collecting cost data. As shown in table 404, Supplier₁ may provide its costs as: Cost Driver A, 10; Cost Driver B, 5; Cost Driver C, 10; Cost Driver D, 25; and Cost Driver E, 15. One skilled in the art will recognize that a supplier could provide costs for all of the cost drivers or for some of the cost drivers. The supplier could provide costs in any denomination, such as, for example, dollars or fractions of a dollar. Additionally, the data collection tool may use a table format, as shown in FIG. 4, or any other format.

Table 406 is a sample table that may be produced based on an analysis of costs provided by Supplier₁ and Supplier₂. Table 406 may be produced and/or recorded by cost analysis processor 106. As shown in table 406, Supplier₂ may provide its costs as: Cost Driver A, 5; Cost Driver B, 10; Cost Driver C, 5; Cost Driver D, 20; and Cost Driver E, 25. Using the data provided, cost analysis processor 106 may determine the Best in Class cost structure by combining the best available cost for each cost driver. In one embodiment, there may be a reason why the best available costs for a cost driver is not determined.

Therefore, the Best in Class cost structure may include estimating the cost for the desired or appropriate cost driver.

In the example of FIG. 4D, Supplier₁ provides the Best in Class cost for Cost Driver B (i.e., 5) and Cost Driver E (i.e., 15). Supplier₂ provides the Best in Class cost for Cost Driver A (i.e., 5), Cost Driver C (i.e., 5), and Cost Driver D (i.e., 20). Therefore, the Best in Class cost structure would be: Cost Driver A, 5; Cost Driver B, 5; Cost Driver C, 5; Cost Driver D, 20; and Cost Driver E, 15.

Cost analysis processor 106 may also determine the industry average cost structure by calculating the average cost for each cost driver. In this example, the industry average cost structure would be: Cost Driver A, 7.5; Cost Driver B, 7.5; Cost Driver C, 7.5; Cost Driver D, 22.5; and Cost Driver E, 20. One skilled in the art will appreciate that cost analysis processor 106 may determine other cost structures, such as an industry mean cost structure or a industry high cost structure. Additionally, cost analysis processor 106 may determine, for example, a Best in Class price by combining the Best in Class costs for all of the cost drivers. Other prices may be determine in a similar fashion.

Table 408 is a sample table that may be produced associated with a supplier. In one embodiment, table 408 may be produced by cost analysis processor 106. As shown in table 408, cost analysis processor 106 may perform gap analysis to determine, for example, the gaps between costs of Supplier₁ and industry costs. For example, the gap from the industry average may be determined for each cost driver. For Supplier₁, the gap from industry average is: Cost Driver A, +2.5; Cost Driver B, −2.5; Cost Driver C, +2.5; Cost Driver D, +2.5; and Cost Driver E, −5. In total, Supplier₁ has a price that is 5 under the industry average. Similarly, the gap from the Best in Class cost may be determined for each cost driver. For Supplier₁, the gap from Best in Class is: Cost Driver A, +5; Cost Driver B, 0; Cost Driver C, −5, Cost Driver D, +5; and Cost Driver E, 0. One skilled in the art will recognize that other cost comparisons may be determined for a supplier consistent with the present invention. For example, using an industry mean, cost analysis processor 106 may identify, for a given supplier, any gaps between the supplier's costs and the industry mean costs. These gaps could be determined, for example, for cost drivers, for sub-cost drivers, or for total price.

In another embodiment of the present disclosure, a commodity may be evaluated to determine cost drivers that contribute to the overall cost of providing the commodity. Considerations in this evaluation may include, for example, the materials that make up the commodity or the process for providing the commodity as well as data from for example, a supplier, a purchaser, or both. The commodity evaluation may include, for example, identifying suppliers of the commodity and determining cost drivers of the commodity. Suppliers of the commodity may be contacted to determine costs for each identified cost driver. The suppliers' costs may then be analyzed to create cost models to assist a purchaser in managing commodity prices.

The analysis of a commodity may include identifying a process flow of the steps a supplier takes to produce the commodity. Such a process flow might include steps identified as cost drivers, such as purchasing raw material, operations, logistics, and overhead. Where the identified cost drivers are more general categories or steps, the cost drivers could be further analyzed to identify sub-cost drivers that contribute to the overall cost of the associated cost driver or commodity. In this way, a commodity may be broken down into a collection of cost drivers (and sub-cost drivers) that, taken together, constitute the cost to a supplier of providing the commodity.

The collection of cost drivers may be used to produce a data collection tool, such as a spreadsheet of the cost drivers, for obtaining supplier-specific costs from suppliers of a commodity. The suppliers' may then be analyzed to create cost models including, for example, a cost model for each supplier or a composite model for an entire industry. For each cost driver, a mean of all of the supplier's costs may be calculated to achieve an industry mean cost structure. A Best in Class cost model may be developed by combining the best supplier cost for each cost driver. By combining the Best in Class costs, a Best in Class price for the commodity may be calculated. These and other cost models may be produced, for example, to assist a purchaser in managing commodity costs.

Industrial Applicability

The results of the cost analyses may be used as a negotiation tool between a purchaser and the supplier. For example, a purchaser could demonstrate to a supplier where the supplier's cost structure gaps are relative to the average or mean of the industry. By disclosing only industry-wide data such as an industry average or industry mean, the purchaser would protect the confidentiality of other suppliers' data. The supplier could be encouraged to identify causes for the gaps and could be given an opportunity to close some of those gaps, thus reducing the supplier's costs. In this way, supplier savings could be passed on to the purchaser in the form of reduced commodity prices. Gaps could occur, for example, in any areas of cost involving material procurement, logistics improvements, cost structure alignment, logistics flow, capital improvement and process changes. A supplier could focus cost-reduction efforts on cost drivers with the largest gaps to the industry mean and submit new data to a purchaser.

If a supplier is unable or unwilling to adjust costs, the purchaser may evaluate the risks to select a new supplier, including developing risk management plans. By understanding the risk to re-source a commodity, the purchaser may effectively manage costs and ensure maximum savings by reducing the number of suppliers or eliminating more expensive suppliers. If a supplier's overall cost is below the industry mean, negotiations may focus on cost drivers or sub-cost drivers where there is room for improvement, thus lowering costs even more. Thus, systems consistent with the present invention enable a purchaser to exercise control over its commodity prices.

A purchaser could also use the analyzed cost data to reach an agreement with a supplier for a period of time. For example, a supplier may agree to maintain an agreed upon cost structure for a period of years, enabling the purchaser to project future costs and savings with confidence. Additionally, the purchaser and supplier could agree to conditions under which an accepted cost model would change. For example, for a cost driver that is not constant, such as the price of copper on the open market, the supplier might agree to keep the cost fixed unless the price of copper rises or falls more than 10% from a current rate. In such a case, the purchaser could agree to pay a price based on an adjusted cost for the copper cost driver. In one embodiment, the cost model may be based on a current or recent cost of the material. For example, the current cost of copper may be used in an equation for determining the ultimate cost. In this way, relevant market factors may be utilized in determining appropriate pricing. Systems consistent with the present invention thus enable a purchaser to control its commodity prices even in variable situations.

Systems and methods are thus provided for improving commodity management. Using systems consistent with the present invention, a purchaser of commodities may obtain and retain lower prices within an industry, understand gaps in a supplier's cost structure to improve, possibly optimize, overall costs, consolidate a supply base by reducing the number of suppliers, minimize business risks, and reduce development time for new products.

Systems consistent with the present invention overcome problems in traditional commodity management systems. For example, in traditional systems, suppliers of commodities exercise a great deal of control over prices, particularly prices for specially designed commodities or large commodities with few suppliers. By analyzing suppliers' cost structures, systems consistent with the present invention give purchasers more leverage to negotiate lower prices. Furthermore, by focusing on cost rather than price, systems consistent with the present invention establish a robust cost structure that can be easily adapted to changes in underlying cost drivers.

Using systems consistent with the present invention, once a cost model is in place, future costs can be quickly and accurately predicted. For example, a proposed design change may involve replacing a part in the commodity. The cost for the replacement part may quickly and easily be entered into the cost model to determine the effect of the proposed design change on the overall commodity price. In addition, the pricing for wire bundles of different lengths, for example, may be appropriately determined based on the cost model.

A cost model generated using systems consistent with the present invention may be updated periodically to reflect fluctuations in cost drivers. For example, a cost model may be updated to reflect a change in raw material or labor costs. Updating may be performed, for example, using data provided by suppliers. An automated updating process may be used that notes market fluctuations and automatically updates the cost drivers affected. In this way, systems and methods consistent with the present invention may provide robust and useful cost models.

In an embodiment of the present invention, a cost model may be combined with a design tool. In this way, cost estimates may be accurately provided at an early stage in the design process. Furthermore, the cost implications of design alternatives may be considered quickly and easily during the design process.

Systems consistent with the present invention could be applied to any type of commodity. For example, additional price reductions could result if suppliers applied systems consistent with the present invention to their own suppliers, analyzing cost drivers all the way down the supply chain. The present invention provides systems and methods that may be applied to any business that purchases commodities, including, for example, makers of construction equipment and automobile manufacturers. Furthermore, consultants may use systems consistent with the present invention, for example, to analyze a company's cost structure.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method of establishing a cost model for a commodity, comprising:
identifying a plurality of suppliers of the commodity;
analyzing the commodity to determine cost drivers associated with supplying the commodity;
determining a supplier-specific cost associated with the cost drivers for the plurality of suppliers; and
comparing the supplier-specific costs to establish a commodity cost model.

2. The method of claim 1, wherein the analyzing step further includes:
establishing a plurality of cost drivers corresponding to steps in supplying the commodity;
for each cost driver, identifying quantifiable data elements as sub-cost drivers.

3. The method of claim 1, wherein the determining step further includes:
providing a data collection tool to a supplier including a list of the cost drivers.

4. The method of claim 3, wherein the data collection unit implements an open book format.

5. The method of claim 1, wherein the comparing step further includes:
determining an industry mean for a specific cost driver; and
analyzing a gap between a supplier's cost and the industry mean for the specific cost driver.

6. The method of claim 1, wherein the comparing step further includes:
determining a Best in Class cost for a specific cost driver; and
analyzing a gap between a supplier's cost and the Best in Class cost for the specific cost driver.

7. The method of claim 1, further including:
using the commodity cost model to negotiate a lower price for the commodity.

8. The method of claim 1, further including:
using the commodity cost model to project prices of the commodity into the future.

9. A method of establishing a Best in Class cost model for a commodity, comprising:
identifying a plurality of suppliers of the commodity;
establishing a plurality of cost drivers that contribute to a total cost of the commodity;
determining an actual cost associated with the cost drivers for each of the plurality of suppliers; and
combining the lowest actual cost for each cost driver to create the Best in Class cost model for the commodity.

10. The method of claim 9, further including:
for a specific cost driver, analyzing a variance between the Best in Class cost model and an actual cost for a supplier.

11. The method of claim 9, further including:
identifying at least one gap for one cost driver for a supplier; and
determining a revised actual cost for the one cost driver for the supplier.

12. The method of claim 9, further including:
using the Best in Class cost model to negotiate a lower price for the commodity.

13. The method of claim 9, further including:
using the Best in Class cost model to project prices of the commodity in the future.

14. A method of analyzing costs of a commodity, comprising the steps of:
analyzing the commodity to determine cost drivers associated with supplying the commodity;
determining a supplier-specific cost associated with the cost drivers for a plurality of suppliers of the commodity; and
calculating an industry mean for each cost driver based on the supplier-specific costs to create an industry mean cost model.

15. The method of claim 14, wherein the calculating step includes performing multi-variant analysis.

16. The method of claim 14, wherein the calculating step includes using box plot tools.

17. The method of claim 14, further including:
identifying gaps between the industry mean and the supplier-specific costs for a particular supplier.

18. The method of claim 17, further including:
evaluating the largest gaps for the particular supplier.

19. The method of claim 14, further including:
using the industry mean cost model to negotiate a lower price for the commodity.

20. The method of claim 14, further including:
using the industry mean cost model to project prices of the commodity in the future.

21. A system for establishing a cost model for a commodity, comprising:
a commodity analysis processor that determines a plurality of cost drivers associated with supplying the commodity;
a supplier interface that obtains a supplier-specific cost associated with the cost drivers from a plurality of suppliers of the commodity; and
a cost analysis processor that compares the supplier-specific costs to establish a commodity cost model.

22. The system of claim 21, wherein the cost analysis processor combines the lowest supplier-specific cost for each cost driver to create a Best in Class cost model for the commodity.

23. The system of claim 21, wherein the cost analysis processor calculates an industry mean for each cost driver to create a commodity cost model.
